(19) United States
(12) Patent Application Publication
(10) Pub. No.: US 2024/0248691 A1
(43) Pub. Date: Jul. 25, 2024

(54) DETECTING SOFTWARE CODE ANOMALIES BASED ON ORGANIZATIONAL INFORMATION

(71) Applicant: Dell Products L.P., Round Rock, TX (US)

(72) Inventors: Yuval Harduf, Yahud (IL); Valerie Lotosh, Ramat-Gan (IL); Jehuda Shemer, Kfar Saba (IL)

(21) Appl. No.: 18/098,931

(22) Filed: Jan. 19, 2023

(51) Int. Cl. G06F 8/41; G06F 8/77

(52) U.S. Cl. CPC G06F 8/433; G06F 8/77

(57) ABSTRACT

Methods, apparatus, and processor-readable storage media for detecting software code anomalies based on organizational information are provided herein. An example computer-implemented method includes generating at least one first data structure comprising information indicating dependencies between software modules associated with a software project of an organization; determining portions of the software project that are assigned to respective groups of individuals associated with the organization based at least in part on a second data structure, where the second data structure includes information indicating an organizational structure; detecting one or more anomalies in the assignment of the portions of the software project corresponding to the dependencies in the first data structure using one or more anomaly criteria, with respect to the information in the second data structure; and automatically causing one or more actions to be performed to mitigate at least a portion of the one or more anomalies.

### FIELD

The field relates generally to information processing systems, and more particularly to software code analysis using such systems.

### BACKGROUND

Static code analysis generally refers to a process for analyzing one or more software applications, or portions thereof, without executing them. Static code analysis techniques primarily analyze the source code to detect programming issues. Such techniques often cannot detect other types of issues, for example, relating to how the code is organized and maintained by a given organization.

### SUMMARY

Illustrative embodiments of the disclosure provide techniques for detecting software code anomalies based on organizational information. An exemplary computer-implemented method includes generating at least one first data structure comprising information indicating dependencies between a plurality of software modules associated with a software project of an organization; determining portions of the software project that are assigned to respective groups of one or more individuals associated with the organization based at least in part on a second data structure, wherein the second data structure comprises information indicating an organizational structure of the organization; detecting one or more anomalies in the assignment of the portions of the software project corresponding to the dependencies in the first data structure using one or more anomaly criteria, with respect to the information in the second data structure; and automatically causing one or more actions to be performed to mitigate at least a portion of the one or more anomalies.

Illustrative embodiments can provide significant advantages relative to conventional code analysis techniques. For example, technical problems associated with detecting software anomalies are mitigated in one or more embodiments by automatically identifying information related to code assignments of individuals within an organization and detecting one or more anomalies in the code assignments with respect to information corresponding to an organizational structure of the organization.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for detecting software code anomalies based on organizational information in an illustrative embodiment.

FIG. 2 shows a call graph of software modules assigned to different owners in an illustrative embodiment.

FIG. 3 shows a flow diagram of source code parsing process in an illustrative embodiment.

FIG. 4 shows an example of a process for deriving logical layers in an illustrative embodiment.

FIG. 5 shows a flow diagram of a process for detecting software code anomalies based on organizational information in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Generally, conventional static analysis techniques can identify programming issues, but do not identify issues with code ownership as they do not track ownership and ownership dependencies. Dynamic code analysis techniques typically are performed while a software application is running (for example, by providing test inputs and analyzing the response of the application), and also fail to identify issues with code ownership.

The term code ownership in this context and elsewhere herein is intended to be broadly construed so as to encompass, for example, code ownership arising from one or more developers or one or more groups of developers that are assigned to and/or responsible for maintaining, developing, testing, and/or triaging respective portions of the source code. In this context, the one or more developers or the one or more groups of developers are generally referred to as “owners” or “code owners.” It is noted that the terms code ownership and owner are determined distinctly from any underlying legal rights of the source code (e.g., copyright ownership).

Existing tools also do not address architecture violations (e.g., resulting from code that is improperly placed), or issues resulting from inefficient usage patterns (e.g., frequent access of modules owned by different teams). Such issues are particularly problematic when the software module includes special functionality that should be assigned to an owner having knowledge in that area. As an example, an owner having knowledge of software security should be assigned to an encryption module to determine whether appropriate coding mechanisms (e.g., interface isolation) and/or tests have been implemented.

Ownership inconsistencies (also referred to herein as anomalies) between the structure of a given organization and code ownership can cause various types of inefficiencies, such as inefficient allocation of resources (including developer and compute resources), duplicate portions of code, slower build times (e.g., due to excess recompilation), and increased time spent to coordinate dependencies between teams.

Some embodiments described herein can identify code ownership anomalies that manifest at multiple layers of software code and/or system resolutions. For example, anomalies at a subsystem level can relate to misplaced software modules and/or ownership conflicts. Anomalies at a module and/or component level can relate to incorrect ownership, multiple ownership, no ownership, lack of formal interfaces (including compatibility and/or versioning), cross access (e.g., when two components access each other, especially if owned by different teams) and/or circular access (e.g., when access between more than two components corresponds to a cycle in a call graph). Anomalies at a file and/or object level can relate to a file being placed in an incorrect module, a file not being owned by the module owners, functions and/or other code snippets that are placed in an incorrect file, and/or a file with multiple contributors from different teams. Also, anomalies at a function level (e.g., application programming interfaces (APIs)) can relate to encapsulation breaches between teams, implementations split across interfaces, and/or duplicate code. Anomalies involving the software infrastructure can also be identified by analyzing ownership information, as described in more detail elsewhere herein.

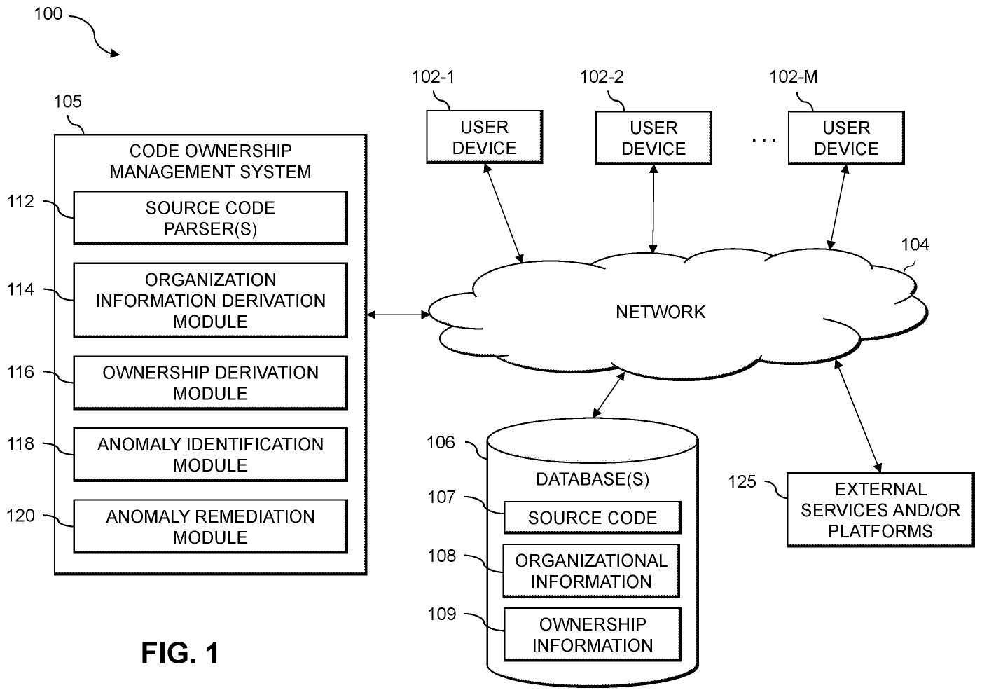

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a code ownership management system 105.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the code ownership management system 105 can have at least one associated database 106 configured to store data pertaining to, for example, source code 107, organizational information 108, and ownership information 109. It is to be appreciated that the organizational information 108, in some embodiments, can be stored on one or more human resource (HR) systems, one or more email systems, and/or organizational management systems. Source code 107 and related information, in some embodiments, can be stored in one or more code repositories (e.g., git, GitHub, SVN, etc.) or other developer code management systems.

An example database 106, such as depicted in the present embodiment, can be implemented using one or more storage systems associated with the code ownership management system 105. Such storage systems can comprise any of a variety of different types of storage including network-attached storage (NAS), storage area networks (SANs), direct-attached storage (DAS) and distributed DAS, as well as combinations of these and other storage types, including software-defined storage and object storage. In at least some embodiments, an example database 106 can comprise a type of software database, such as a relational database or a NoSQL database. Also associated with the code ownership management system 105 are one or more input-output devices, which illustratively comprise keyboards, displays or other types of input-output devices in any combination. Such input-output devices can be used, for example, to support one or more user interfaces to the code ownership management system 105, as well as to support communication between code ownership management system 105 and other related systems and devices not explicitly shown.

Additionally, the code ownership management system 105 in the FIG. 1 embodiment is assumed to be implemented using at least one processing device. Each such processing device generally comprises at least one processor and an associated memory, and implements one or more functional modules for controlling certain features of the code ownership management system 105.

More particularly, the code ownership management system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the code ownership management system 105 to communicate over the network 104 with the user devices 102, and illustratively comprises one or more conventional transceivers.

The code ownership management system 105 further comprises one or more source code parsers 112, an organization information derivation module 114, an ownership derivation module 116, anomaly identification module 118, and an anomaly remediation module 120.

Generally, the one or more source code parsers 112 obtain source code (e.g., source code 107) pertaining to one or more applications for generating call information (e.g., in the form of a code call graph) and dependency information (e.g., in the form of a software module dependency graph). The organization information derivation module 114 derives organizational information 108 (e.g., in the form of an organization hierarchy graph). The organizational information 108, in some embodiments, can be derived based at least in part on data maintained by a given organization (e.g., human resource data) and/or data obtained from one or more external services and/or platforms (e.g., via one or more APIs of one or more social media platforms and/or human resource services).

The ownership derivation module 116 derives ownership information 109 for portions of the source code 107. For example, the ownership information can be derived at one or more levels for a given application (e.g., per file, per module, and/or per function), and can provide indications of ownership entities assigned to respective portions of the source code 107. Accordingly, in some embodiments, the ownership information 109 can indicate one or more groups or one or more teams of developers that are responsible for developing, testing, and/or triaging respective portions of the source code 107. The anomaly identification module 118 identifies anomalies between the organizational information 108 and the ownership information 109, and the anomaly remediation module 120 determines options for remediating at least a portion of the identified anomalies. In some embodiments, the anomaly remediation module 120 can trigger one or more alerts for the identified anomalies and/or provide the determined remediation options to one or more users associated with one or more of the user devices 102 via a remediation dashboard, for example. In at least one embodiment, the anomaly remediation module 120 can automatically remediate at least one of the identified code anomalies (e.g., by modifying the users and/or teams assigned to a given portion of the source code 107). These and other elements of the code ownership management system 105 are described in more detail elsewhere herein.

Optionally, the computer network 100 can further include one or more external services and/or platforms 125. For example, the external services and/or platforms 125 can include tools (e.g., online issue tracking systems such as Jira) or code management services (e.g., code repository services such as GitHub), which can integrate with the code ownership management system 105. By way of example, the code ownership management system 105 can interact with such external services and/or platforms 125 (e.g., via one or more APIs) to perform one or more of the determined remediation options, as described in more detail elsewhere herein.

It is to be appreciated that this particular arrangement of elements 112, 114, 116, 118, and 120 illustrated in the code ownership management system 105 of the FIG. 1 embodiment is presented by way of example only, and alternative arrangements can be used in other embodiments. For example, the functionality associated with the elements 112, 114, 116, 118, and 120 in other embodiments can be combined into a single module, or separated across a larger number of modules. As another example, multiple distinct processors can be used to implement different ones of the elements 112, 114, 116, 118, and 120 or portions thereof.

At least portions of elements 112, 114, 116, 118, and 120 may be implemented at least in part in the form of software that is stored in memory and executed by a processor.

It is to be understood that the particular set of elements shown in FIG. 1 for code ownership management system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the code ownership management system 105 and database(s) 106 can be on and/or part of the same processing platform.

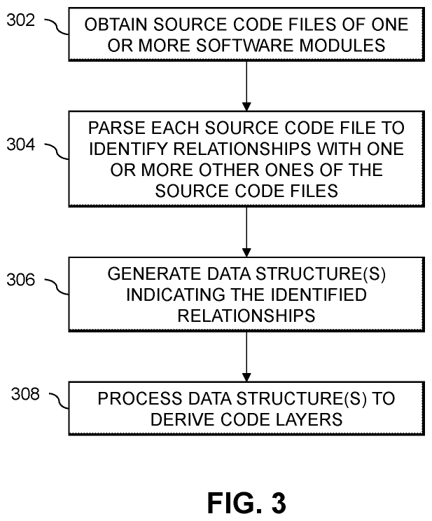

An exemplary process utilizing elements 112, 114, 116, 118, and 120 of an example code ownership management system 105 in computer network 100 will be described in more detail with reference to, for example, the flow diagrams of FIGS. 3-5.

Changes to source code for applications over time often cause inconsistencies related to code ownership. For example, some software projects include a large number of source code files (e.g., thousands or more) written by many different developers over a long period of time. Such software projects accumulate ownership inconsistencies, for example, due to mistakes, shortcuts, and/or organizational changes. For example, responsibilities of developers can change and/or teams can be created and/or destroyed. Such inconsistencies can result in some portions of the code being assigned to the wrong developer or team, and other portions of code may not be assigned at all. These issues can cause problems with maintaining the code and also reduce the speed at which the application is developed. The source code can also include portions of code that perform substantially the same function, thereby increasing the size of the source code. Additional examples of issues include functions that are located in a mismatching file or functionality that is incorrectly placed within an interface.

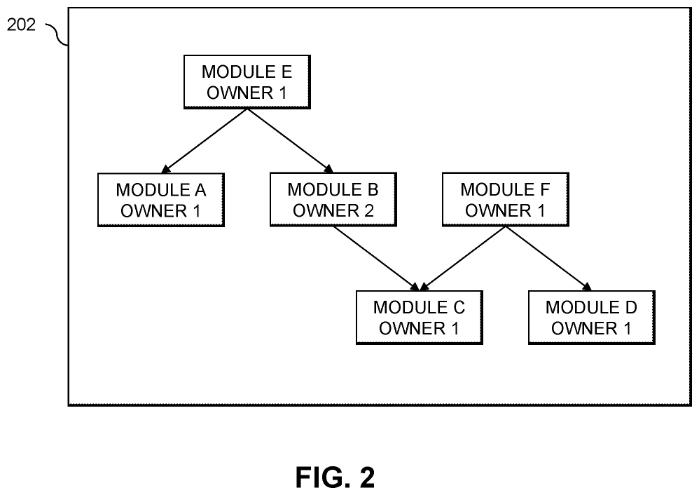

FIG. 2 shows a call graph 202 of software modules assigned to different owners in an illustrative embodiment. The call graph 202 includes six software modules (labeled modules A-F). In this example, all of the modules are assigned to owner 1 except for module B, which is assigned to owner 2. The arrows shown in the call graph 202 represent the relationship between the modules. For example, modules A, C, and D can correspond to low-level infrastructure of a software project (as they are not being used by other modules), but have no dependencies of their own. Module B can correspond to an intermediate component, and modules E and F can be applications that use the other modules as indicated by the arrows. The call graph 202 can indicate that a possible ownership issue exists, as module B is assigned to owner 2 and is only used by modules assigned to owner 1. This type of ownership issue often results from organizational changes. For example, all of the modules in FIG. 2 may have initially been assigned to owner 1, and a reorganization of teams and/or individuals may have resulted in module B being assigned to owner 2. Additionally, software code frequently evolves over time, thereby causing shifts in ownership for software components (e.g., modules and files).

According to at least some embodiments, a process to identify code ownership issues generally can include the following stages: source code parsing, organizational information derivation, code ownership derivation, and anomaly identification and remediation. Each of these stages is now discussed in more detail.

The source code parsing stage, in some embodiments, includes obtaining source code for a given software project, and using one or more source code parsing tools (e.g., source code parsers 112) to derive a call graph.

The source code parsing tools may be implemented in some embodiments as one or more static analysis tools. In at least some embodiments, a source code parser can parse source code to produce one or more abstract syntax trees (ASTs). An AST generally refers to a data structure that represents the structure of source code, and can be used to identify duplicate code instances, for example.

FIG. 3 shows a flow diagram of a source code parsing process in an illustrative embodiment. The process in FIG. 3 can be performed at least in part by source code parsers 112, for example.

Step 302 includes obtaining source code files of one or more software modules (e.g., from database 106) for a given software project. The term “software module” in this context and elsewhere herein is intended to be broadly construed so as to encompass, for example, one or more source code files, or portions or combinations thereof, or other types of software.

Step 304 includes parsing each source code file to identify relationships with one or more other ones of the source code files obtained at step 302. In some embodiments, step 304 may include identifying whether each source code file externally accesses one or more of the other files, such as by identifying any functions or global variables that the source code file uses from other files.

Step 306 includes generating one or more data structures that indicate the relationships identified in step 304. In some embodiments, the one or more data structures can correspond to one or more graphs showing such relationships. The one or more data structures can represent the relationship for multiple resolutions (e.g., for files, modules, and/or directories) in a single data structure, or multiple data structures (e.g., one data structure for each of the multiple resolutions).

Step 308 includes processing the data structures to derive one or more code layers of the source code, such as modules, infrastructure, external dependencies, and/or other code structures. It is noted that in some embodiments, metadata can be added to the source files and/or modules (e.g., via special comments and/or tags), which can be used to improve the information gathered by the process.

The code layers can be derived in some embodiments by generating a module dependency graph based on the data structures generated at step 306, for example. Generally, a module dependency graph includes nodes corresponding to software modules and edges representing relationships between the nodes. In more detail, a module for purposes of generating the module dependence graph can be identified as an entity of the software project that satisfies one or more of the following criteria: (i) the entity is associated with a separate code repository (e.g., a separate git repository) from other entities in the software project; (ii) the entity comprises a file that describes the relationships among the files in the software project (e.g., a “makefile”); and (iii) the entity is referred to using an identifier (e.g., a name) by one or more other modules. Such criteria are merely non-limiting examples for identifying and establishing software modules, and it is to be appreciated that alternative and/or additional criteria can be used in other embodiments. The term “entity” in this context and elsewhere herein depends on the programing language and/or coding conventions of a given organization. For example, in some programming languages, each file can be considered a separate module, whereas in other programming languages a set of files (possibly in a separate directory than other files) can be considered a module. In some instances, multiple directories can constitute a module. Typically, the multiple directories would correspond to a directory hierarchy, but disparate directories are also possible, including at levels corresponding to one or more of: subsystem, module, service, microservice, component, class, library, object, project, assembly, and/or the like.

If the data structures generated at step 306 are implemented as one or more parsed code graphs, then the module dependency graph can be derived as a subgraph of the parsed code graph, where the nodes belonging to a given module are collapsed into a single module node. The edges of the parsed code graph are also moved to the collapsed node. Accordingly, the module level graph will have an edge between module A and module B if (i) an entity in module A is calling an entity in module B and (ii) an entity in module A is dependent on an entity in module B for a given build or compilation. Every node in the module dependency graph can be marked as an internal node or an external node. An external node corresponds to a module that is not maintained as part of the software project (e.g., operating system modules, third-party libraries, services, opensource libraries/services, and/or modules provided and maintained by other companies. An internal module refers to a module that is provided and maintained by the organization.

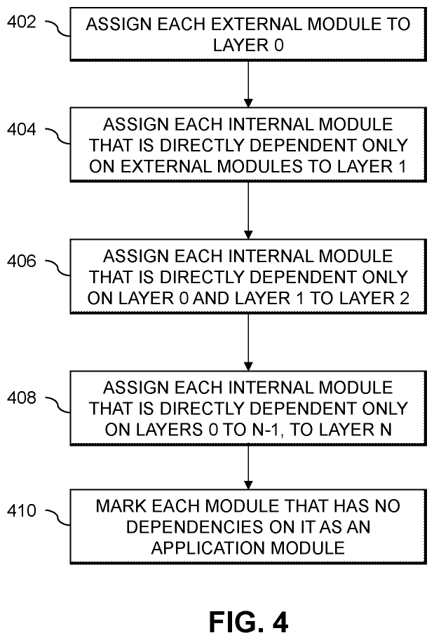

FIG. 4 shows an example of a process for deriving logical layers in an illustrative embodiment. Step 402 includes assigning each external module to layer 0. Step 404 includes assigning each internal module that is directly dependent (e.g., as indicated by edges in the graph) only on external modules to layer 1. Step 406 includes assigning each internal module that is directly dependent only on layer 0 and layer 1 to layer 2. Step 408 includes assigning each internal module that is directly dependent only on layer 0 to layer N-1, to layer N. Step 410 includes marking each module that has no dependencies on it as an application module.

It is noted that if a circular dependency issue exists, then the corresponding dependencies collapse into a single layer. In some embodiments, the process depicted in FIG. 4 can be repeated when the circular dependency is resolved, as this will generally cause one or more modules to change layers.

It is to be appreciated that infrastructure layers can correspond to a set of lower layers, and thus there will potentially be many modules that are dependent on them. For example, in some embodiments, the set of infrastructure layers can be any layer that is below a threshold layer (or based on a percentage of the overall layers). The application modules can be a set of higher layers, and thus have fewer (or no) modules that are dependent upon them. It is to be appreciated that the infrastructure layers and the application modules can be defined based on one or more thresholds related to the layers and/or the number of dependencies. In some embodiments, a given module can be manually labeled (e.g., using a tag or hint) as being an infrastructure layer or an application module.

One or more embodiments can derive an organizational data structure (e.g., organizational graph) using information from one or more tools or services (e.g., HR tools) in the organizational information derivation stage. For example, the data structure can be derived by accessing such tools and/or services to identify teams and the developers that are part of the teams. This information is often available through applications and services and can be used to determine hierarchical information within the organization and the teams (including team leaders, team members, managers, etc.). In at least one embodiment, the hierarchy information within the organization is used to generate a graph indicating the hierarchical structure of the organization, where edges connect different levels of the hierarchy (e.g., edges connecting a team leader and the team members).

The information used to generate the organizational data structure can evolve over time (e.g., members of the organization may leave or move to other teams within the organization). This can lead, for example, to incorrect mappings between teams and team members. Teams can also form and/or dissolve over time, which can cause decisions based on such information to be inaccurate. At least some embodiments described herein can collect and track historical organizational information (e.g., HR information). Collecting the historical organizational information can include, for example, retrieving timestamped information of employee events (e.g., events related to employee manager history) from one or more HR tools or services via one or more APIs. Organizational information can alternatively or additionally be collected on a periodic basis to track such events, which can be helpful if the information is not available from the HR tools. Events can also be added manually if the information is needed and not otherwise available. The historical organizational information can be used to maintain a time-based hierarchical organizational data structure, which can indicate changes to teams, newly created teams, and/or dissolution of teams. Such a data structure can be used to determine code ownership more accurately, as described in more detail elsewhere herein.

The code ownership derivation stage may include determining code ownership at different levels of code (e.g., by file, module, and/or function). A developer and/or team of developers may be associated with each file or module. In more formal terms, code ownership can be expressed as an association function that returns the ownership information for a given entity (e.g., Entity Association(file/module) returns team and/or developer).

In some situations, code ownership is not always clear, and so multiple sources of information can be used to improve the code ownership derivation process. For example, association information can be retrieved from one or more of the following sources: (i) source control information, for example, that identifies users making changes to the files, (ii) continuous improvement (CI)/continuous developments (CD) tool chain definitions or code review information that can indicate members that perform code review of files, (iii) CI/CD tool chain definitions to determine organizational members that merge contents (e.g., pull requests, pushes) in the file; for organizations where developers write tests, the author of such tests is often available and can be used as a factor to determine the owner of the corresponding file; and/or manually entered information. Additionally, any person no longer part of the organization is also taken into consideration. For example, when a person leaves an organization, code ownership can be transferred automatically to the team to which the person belonged (e.g., to a team leader). In some embodiments, explicit information can be provided using metadata or metadata rules. For example, a rule may define that code ownership of all code owned by X transfers to Y. More detailed rules are also possible, such as all code in module M1 owned by X transfers to Y, and code ownership of all code owned by X in module M2 transfers to Z. With regard to code changes, recent changes in a file can be considered more relevant than older changes, for example. Thus, if a module changes ownership, then after some time, some embodiments can assign the new owner(s) to the module. Similarly, developers that have left the organization or moved to a different project/team can also be considered.

As noted above, some embodiments can maintain a time-based hierarchical organizational data structure. In such embodiments, the association function can be modified to take a time parameter (e.g., Entity Association(file/module, timestamp) as an input, and to return a team and/or developer corresponding to the timestamp. The timestamp corresponds to a time that is used to derive the code ownership associations. In some examples, the timestamp can correspond to a “blame” command (e.g., a git blame command), which allows the contents of a file to be examined line by line to see when each line was last modified and who was the author of the modifications, for example. Thus, the hierarchical organization information can be retrieved from the time-based hierarchical organizational data structure as it was at the time of the change.

Consider an example where Developer X moves from team A to team B in August 2020. Changes performed by Developer X before August 2020 should be attributed to team A and not to team B. If ownership of the module has changed after August 2020, then timestamps of later contributions will be identified and associated with the correct team. On the other hand, if ownership of the module moved with Developer X to team B (e.g., due to a management decision to change team ownership), then Developer X will continue to contribute to the module and the newer timestamps will be used to establish code ownership more accurately.

In the anomaly identification and remediation stage, anomalies are identified between the code ownership and the derived organization information, and possible options are identified for remediating at least a portion of the identified anomalies. At least some embodiments can identify one or more of the following types of anomalies: multiple ownership; no ownership; sole file ownership in a module; dependency cycles and ownership cycles; incorrect ownership of a middleware software module; and malformed code structure and/or incorrect assignment of ownership to code.

A multiple ownership issue generally refers to multiple different teams changing the same file or module, which indicates a code ownership issue and/or poor separation of code within the module. Possible remediations for this type of issue can include one or more of assigning the file or module to a single owner, separating contents of the file or module by teams, and changing the location of the file or module.

A no ownership issue generally refers to no owner being identified for a module or file. Possible remediations for a no ownership issue can include assigning ownership to the module or file and/or moving the location of the module or file so that it is owned by another team.

Issues related to sole file ownership in a module can occur when a module that is maintained by a first team is frequently changed by another team, which indicates that the structure of the module may be incorrect. This type of issue can be detected based on one or more criteria (e.g., a threshold number of changes by the second team and/or by comparing a percentage of changes made by the first team and the second team threshold percentage). Possible remediations can include moving the file to a different location, splitting the module, and/or creating proper interfaces.

Dependency cycles and ownership cycles can occur when one or more cycles are detected in the code call graph and/or in the module dependency graph. These types of issues are indicative of code formation issues, and possibly inconsistencies in compilation results. The cycles can also create ownership cycles that can be potential for “blame” loops, where responsibility of the code is continuously passed between multiple owners. Possible remediations can include one or more of splitting the module or file, identifying and improving interface or APIs, moving code between different files or modules, moving file locations, reversing one or more dependencies, and changing ownership of the module or file.

It is noted that in this context, the term “interface” generally refers to a defined boundary used to access certain functionality. Improving an interface generally refers to one or more of the following: (i) improving the definition of the boundary, thereby resulting in improved communication and responsibility division between the teams, (ii) changing the boundary (for example, by moving some of the corresponding source code outside of a module, possibly to the control of another team, thereby shrinking the module); (iii) splitting a module along the interface dividing the functionality between two modules (where each module is possibly owned by a different team); and (iv) changing the boundary of a module to move some of the source code inside the module (where the source code was possibly owned by another team), and moving the ownership to the team that maintains the module, thereby expanding the module.

Incorrect ownership of a middleware software module can occur when an application uses some middleware modules and some infrastructure modules, and the application and infrastructure modules are owned by the same team, but the middleware is owned by another team (similar to the example shown in FIG. 2). This type of issue suggests that the ownership of the middleware component is incorrect. Possible remediations for this type of issue can include at least one of: unifying the ownership of the infrastructure, application, and middleware modules; moving one or more developers working on the middleware module to a different team; creating proper interfaces; and reversing one or more dependencies.

If a discrepancy is intentional (e.g., a special compression library that may require the skillset of a particular team), then creating proper interfaces may include implementing the interfaces to ensure that responsibility and maintenance boundaries are clear. If a discrepancy is unintentional and should be resolved, then defining the interfaces can include changing the boundaries of a given module so that it is absorbed by one team, for example.

With regards to reversing a dependency, consider an example where module X collects data and sends it to module Y. The reverse of this dependency would be module Y asking module X to provide the data that it collected. The result of reversing a dependency result is the same, but the direction of the arrow between the modules is reversed. Incorrect ownership of an infrastructure module occurs when the module is identified as an infrastructure module and more than one team is making changes to it. This type of issue suggests that the infrastructure has no owner. The analysis of these types of issues is similar to the analysis for multiple owners, however, the implications of mismanaged infrastructure modules can be more serious, potentially causing external implications. Possible remediations to address this type of issue can include assigning an owner to the module.

Issues related to malformed code structure or wrong assignment of ownership to code can occur when there is crossover between code of different applications, or between different infrastructure files (e.g., a cycle having a length of two). These issues usually stem from misalignment between code structure and organization structure (e.g., a portion of code has no owner or too many owners), which indicates that the code is not being maintained properly. Sometimes the issue is because of a malformed structure of the code. Possible remediations to address these types of issues can include identifying owners for respective pieces of the code, and then splitting the code in such a way so that it corresponds to that ownership.

At least some embodiments can include automatically performing one or more actions in response to detecting one of the ownership anomaly issues. The actions can include, for example, one or more of: outputting a list of the ownership code ownership anomalies, outputting one or more remediation recommendations that are relevant to the type of detected ownership anomaly, opening a ticket to track the anomaly on bug tracking system, automatically selecting and performing a given remediation action to address the ownership issue, causing a validation of code structure to be performed prior to committing additional code, and causing one or more code merge operations (e.g., commits) to fail.

Some embodiments can also include prioritizing remediation of detected ownership anomalies. This can be particularly helpful in situations where a large number of ownership anomalies have been detected. Some embodiments can determine hierarchical properties associated with code ownership and can use those properties to identify the ownership anomaly issues to prioritize. For example, code ownership properties are often hierarchical, where if a file is in a module, then the owner of that module is likely to be the owner of the entire file. This is also the case for other code granularities (e.g., functions in a given file, objects or methods in a given file, etc.). The remediation operations at different levels of the ownership hierarchy can often affect ownership at higher levels (e.g., by either changing or breaking those ownership relationships).

To prioritize such remediation actions, some embodiments compute a remediation complexity value, X, for a given list of anomalies, where X is a number of remediation steps needed to resolve all anomalies in X. For example, if a file is moved and a module is assigned to a different owner, and that resolves all of the issues in X, then the remediation complexity value is equal to 2. The minimal remediation complexity of X is the smallest number of remediations possible in order to resolve all anomalies of X. This number can be much lower than the number of anomalies as some operations may not remediate the issues and/or some operations may affect higher order entities as noted above.

Some embodiments include obtaining: the code, derived organizational data structure(s), derived ownership information, and a list of remediation options for each anomaly. The inputs are searched to identify a set of remediations that provide a minimal complexity, for example. The set of remediations represents the remediations that should be prioritized.

Searching for the set of remediations that provide the minimal complexity generally is an exponential problem. At least some embodiments can optionally improve the efficiency of the search. For example, remediations that do not affect each other in the hierarchy are independent, and thus can be evaluated on their own without the multiplying effect of the dependencies on other remediations. Generally, the number of dependencies is not very high, and so the performance of the search algorithm is closer to polynomial by performing the evaluation in this manner.

The search algorithm can alternatively or additionally include ordering the anomalies from higher order to lower order (e.g., by iterating according to the code layers from higher to lower or performing a full topological sort (e.g., depth first traversal (DFS)) of the graph, starting with nodes that have the lowest number of dependencies on them). The anomalies can be prioritized in some embodiments according to a top-down order, which can ensure that each anomaly is visited only once. Following the sorting, this optimization results in substantially linear performance (e.g., the problem can be solved in O(nlogn) time).

The minimal remediation complexity, in some embodiments, can be used as a measure of an amount of misalignment between an organization and its code base, referred to herein as organizational entropy. For example, an organizational entropy of 0 indicates that everything is in order, whereas higher organizational entropy values indicate increasing levels of ownership misalignment. This organizational entropy provides an organization-wide view indicating the amount of misalignment between the organization structure and its codebase.

Tracking changes to organizational entropy values over time can effectively measure developer behavior. In some embodiments, organizational entropy is computed periodically (daily, weekly, etc.), and the organizational entropy values can be output to a dashboard (e.g., in the form of a graph). Stable or decreasing organizational entropy values are generally desirable relative to increasing organizational entropy values. Tracking code commits (e.g., git commits) and organizational changes during the organizational entropy measurement period can help identify, for example, problematic code areas, issues with coding practices in specific parts of the organization, and/or ownership sensitivity pertaining to particular individuals or teams.

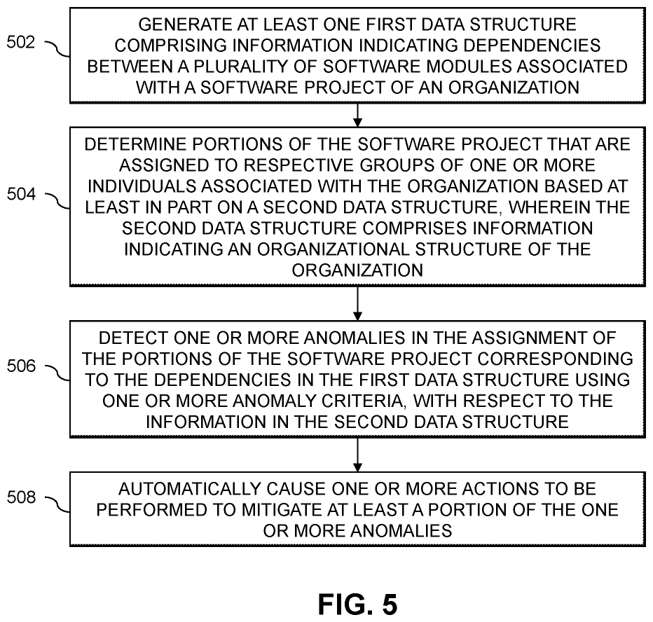

FIG. 5 is a flow diagram of a process for detecting software code anomalies based on organizational information in an illustrative embodiment. It is to be understood that this particular process is only an example, and additional or alternative processes can be carried out in other embodiments.

In this embodiment, the process includes steps 502 through 508. These steps are assumed to be performed by the code ownership management system 105 utilizing its elements 112, 114, 116, 118, and 120.

Step 502 includes generating at least one first data structure comprising information indicating dependencies between a plurality of software modules associated with a software project of an organization. Step 504 includes determining portions of the software project that are assigned to respective groups of one or more individuals associated with the organization based at least in part on a second data structure, wherein the second data structure comprises information indicating an organizational structure of the organization. Step 506 includes detecting one or more anomalies in the assignment of the portions of the software project corresponding to the dependencies in the first data structure using one or more anomaly criteria, with respect to the information in the second data structure. Step 508 includes automatically causing one or more actions to be performed to mitigate at least a portion of the one or more anomalies.

The generating may include: obtaining and parsing source code corresponding to the software project to derive one or more graphs at one or more corresponding levels, wherein the one or more graphs indicate a code structure of the software project; and deriving the at least one first data structure based at least in part on the one or more graphs. The one or more corresponding levels may include at least one of: a file level, a directory level, and a software module level. The generating the at least one data structure may include identifying a plurality of code layers for the software project, and the plurality of code layers may include two or more of: an external layer comprising at least one of the software modules that is maintained separately from the software project; an application layer comprising at least one of the software modules having a threshold number of dependencies; and one or more infrastructure layers comprising at least one of the software modules having a number of dependencies greater than the threshold number. Each of the software modules may include at least one of the following properties: having an associated code repository; at least one particular type of file indicating a relationship among a plurality of files associated with software project; and an identifier that is used to identify the software module by one or more other software modules. The second data structure may be generated based at least in part on one or more titles of the respective individuals and one or more relationships between the respective individuals. For a given portion of the software project, the determining may be based on at least one of: information identifying individuals that interact with the given portion of the software project; and one or more timestamps corresponding to at least a portion of the interactions. The interactions may correspond to at least one of: creating at least one test for testing the given portion of the software project; modifying the given portion of the software project; and one or more merge operations affecting the given portion of the software project. The one or more anomaly criteria may include at least one of: detecting two or more of the groups of the organization are assigned to a same portion of the software project; detecting that no group is assigned to a given portion of the software project; detecting that at least one individual from a first one of the groups interacts with a portion of the software project that is assigned to a different, second one of the groups; detecting that individuals from at least two different ones of the groups are assigned to a given portion of the software project corresponding to an infrastructure layer; and detecting that a first one of the groups interacts with a given portion of the software project that is located between two layers of the software project, wherein each of the two layers are assigned to a second one of the groups that is different than the first group. The one or more actions may include at least one of: outputting a list that identifies at least a portion of the one or more anomalies; outputting information for remediating at least a portion of the of the one or more anomalies; creating a ticket to track at least a portion of the one or more anomalies in a ticket tracking system; performing a code structure validation process; preventing one or more code merge operations; and performing one or more remediation actions, wherein the one or more remediation actions comprise at least one of: automatically adjusting one or more of: at least one individual and at least one group assigned to a given portion of the software project, and automatically changing a location of at least one part of a given portion of the software project.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to identify software code anomalies due to inconsistencies between code ownership and organization structure. These and other embodiments can effectively overcome problems associated with existing software analysis techniques that often fail to identify issues related to code ownership. For example, some embodiments are configured to identify and mitigate anomalies in software code by identifying code assignments of individuals within an organization to portions of code, and comparing that information to the organizational structure. These and other embodiments can effectively identify and mitigate software code issues resulting from code ownership anomalies.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

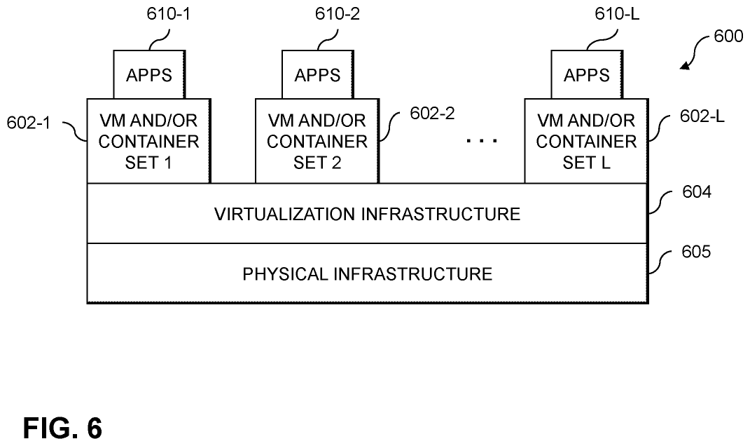

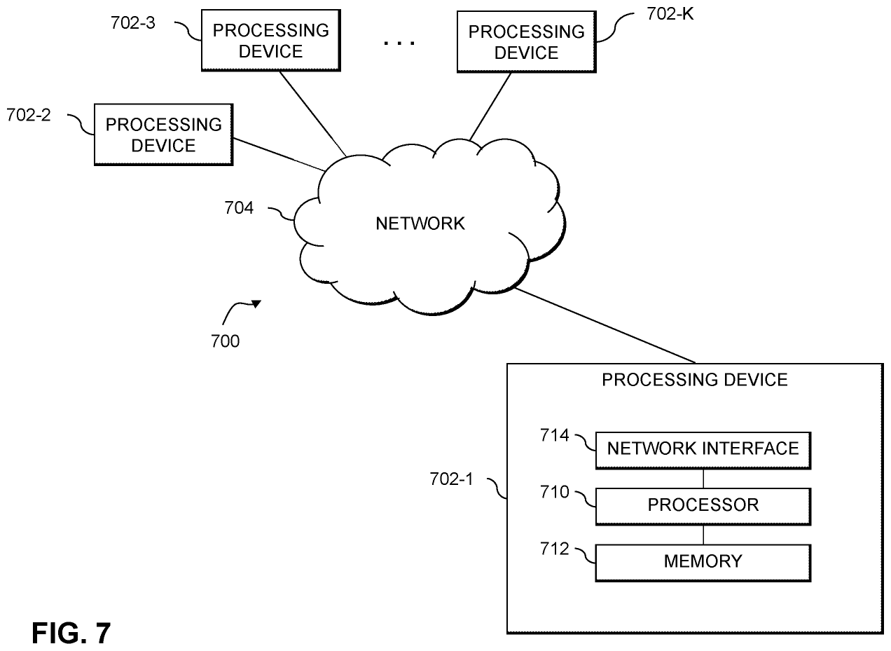

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an ASIC, an FPGA or other type of processing circuitry, as well as portions or combinations of such circuitry elements.

The memory 712 comprises RAM, ROM or other types of memory, in any combination.

The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
generating at least one first data structure comprising information indicating dependencies between a plurality of software modules associated with a software project of an organization;
determining portions of the software project that are assigned to respective groups of one or more individuals associated with the organization based at least in part on a second data structure, wherein the second data structure comprises information indicating an organizational structure of the organization;
detecting one or more anomalies in the assignment of the portions of the software project corresponding to the dependencies in the first data structure using one or more anomaly criteria, with respect to the information in the second data structure; and
automatically causing one or more actions to be performed to mitigate at least a portion of the one or more anomalies;
wherein the method is performed by at least one processing device comprising a processor coupled to a memory.

2. The computer-implemented method of claim 1, wherein the generating comprises:
obtaining and parsing source code corresponding to the software project to derive one or more graphs at one or more corresponding levels, wherein the one or more graphs indicate a code structure of the software project; and
deriving the at least one first data structure based at least in part on the one or more graphs.

3. The computer-implemented method of claim 2, wherein the one or more corresponding levels comprise at least one of: a file level, a directory level, and a software module level.

4. The computer-implemented method of claim 2, wherein the generating the at least one first data structure comprises identifying a plurality of code layers for the software project, and wherein the plurality of code layers comprises two or more of:
an external layer comprising at least one of the software modules that is maintained separately from the software project;
an application layer comprising at least one of the software modules having a threshold number of dependencies; and
one or more infrastructure layers comprising at least one of the software modules having a number of dependencies greater than the threshold number.

5. The computer-implemented method of claim 1, wherein each of the software modules comprises at least one of the following properties:
having an associated code repository;
at least one particular type of file indicating a relationship among a plurality of files associated with software project; and
an identifier that is used to identify the software module by one or more other software modules.

6. The computer-implemented method of claim 1, wherein the second data structure is generated based at least in part on one or more titles of the respective individuals and one or more relationships between the respective individuals.

7. The computer-implemented method of claim 1, wherein, for a given portion of the software project, the determining is based on at least one of:
information identifying individuals that interact with the given portion of the software project; and
one or more timestamps corresponding to at least a portion of the interactions.

8. The computer-implemented method of claim 7, wherein the interactions correspond to at least one of:
creating at least one test for testing the given portion of the software project;
modifying the given portion of the software project; and
one or more merge operations affecting the given portion of the software project.

9. The computer-implemented method of claim 1, wherein the one or more anomaly criteria comprises at least one of:
detecting two or more of the groups of the organization are assigned to a same portion of the software project;
detecting that no group is assigned to a given portion of the software project;
detecting that at least one individual from a first one of the groups interacts with a portion of the software project that is assigned to a different, second one of the groups;
detecting that individuals from at least two different ones of the groups are assigned to a given portion of the software project corresponding to an infrastructure layer; and
detecting that a first one of the groups interacts with a given portion of the software project that is located between two layers of the software project, wherein each of the two layers are assigned to a second one of the groups that is different than the first group.

10. The computer-implemented method of claim 1, wherein the one or more actions comprise at least one of:
outputting a list that identifies at least a portion of the one or more anomalies;
outputting information for remediating at least a portion of the of the one or more anomalies;
creating a ticket to track at least a portion of the one or more anomalies in a ticket tracking system;
performing a code structure validation process;
preventing one or more code merge operations; and
performing one or more remediation actions, wherein the one or more remediation actions comprise at least one of: automatically adjusting one or more of: at least one individual and at least one group assigned to a given portion of the software project, and automatically changing a location of at least one part of a given portion of the software project.

11. A non-transitory processor-readable storage medium having stored therein program code of one or more software programs, wherein the program code when executed by at least one processing device causes the at least one processing device:
to generating at least one first data structure comprising information indicating dependencies between a plurality of software modules associated with a software project of an organization;
to determine portions of the software project that are assigned to respective groups of one or more individuals associated with the organization based at least in part on a second data structure, wherein the second data structure comprises information indicating an organizational structure of the organization;
to detect one or more anomalies in the assignment of the portions of the software project corresponding to the dependencies in the first data structure using one or more anomaly criteria, with respect to the information in the second data structure; and
to automatically cause one or more actions to be performed to mitigate at least a portion of the one or more anomalies.

12. The non-transitory processor-readable storage medium of claim 11, wherein the generating comprises:
obtaining and parsing source code corresponding to the software project to derive one or more graphs at one or more corresponding levels, wherein the one or more graphs indicate a code structure of the software project; and
deriving the at least one first data structure based at least in part on the one or more graphs.

13. The non-transitory processor-readable storage medium of claim 12, wherein the one or more corresponding levels comprise at least one of: a file level, a directory level, and a software module level.

14. The non-transitory processor-readable storage medium of claim 12, wherein generating the at least one first data structure comprises identifying a plurality of code layers for the software project, and wherein the plurality of code layers comprises two or more of:
an external layer comprising at least one of the software modules that is maintained separately from the software project;
an application layer comprising at least one of the software modules having a threshold number of dependencies; and
one or more infrastructure layers comprising at least one of the software modules having a number of dependencies greater than the threshold number.

15. The non-transitory processor-readable storage medium of claim 11, wherein each of the software modules comprises at least one of the following properties:
having an associated code repository;
at least one particular type of file indicating a relationship among a plurality of files associated with software project; and
an identifier that is used to identify the software module by one or more other software modules.

16. An apparatus comprising:
at least one processing device comprising a processor coupled to a memory;
the at least one processing device being configured:
to generating at least one first data structure comprising information indicating dependencies between a plurality of software modules associated with a software project of an organization;
to determine portions of the software project that are assigned to respective groups of one or more individuals associated with the organization based at least in part on a second data structure, wherein the second data structure comprises information indicating an organizational structure of the organization;
to detect one or more anomalies in the assignment of the portions of the software project corresponding to the dependencies in the first data structure using one or more anomaly criteria, with respect to the information in the second data structure; and
to automatically cause one or more actions to be performed to mitigate at least a portion of the one or more anomalies.

17. The apparatus of claim 16, wherein the generating comprises:
obtaining and parsing source code corresponding to the software project to derive one or more graphs at one or more corresponding levels, wherein the one or more graphs indicate a code structure of the software project; and
deriving the at least one first data structure based at least in part on the one or more graphs.

18. The apparatus of claim 17, wherein the one or more corresponding levels comprise at least one of: a file level, a directory level, and a software module level.

19. The apparatus of claim 17, wherein generating the at least one first data structure comprises identifying a plurality of code layers for the software project, and wherein the plurality of code layers comprises two or more of:
an external layer comprising at least one of the software modules that is maintained separately from the software project;
an application layer comprising at least one of the software modules having a threshold number of dependencies; and
one or more infrastructure layers comprising at least one of the software modules having a number of dependencies greater than the threshold number.

20. The apparatus of claim 16, wherein each of the software modules comprises at least one of the following properties:
having an associated code repository;
at least one particular type of file indicating a relationship among a plurality of files associated with software project; and
an identifier that is used to identify the software module by one or more other software modules.
